(19) United States
(12) Patent Application Publication
(10) Pub. No.: US 2017/0336220 A1
(43) Pub. Date: Nov. 23, 2017

(54) Multi-Sensor Position and Orientation Determination System and Device

(71) Applicant: DAQRI, LLC, Los Angeles, CA (US)

(72) Inventors: Christopher Broaddus, Santa Clara, CA (US); Muzaffer Kal, Los Angeles, CA (US); Wenyi Zhao, Mountain View, CA (US); Ali M. Tatari, Los Angeles, CA (US); Dan Bostan, Los Angeles, CA (US); Saud Akram, Los Angeles, CA (US)

(21) Appl. No.: 15/161,089

(22) Filed: May 20, 2016

(51) Int. Cl. G01C 21/36; G06T 7/10; G06T 19/00; G06T 7/33; G06T 7/285

(52) U.S. Cl. CPC G01C 21/362; G06T 7/33; G06T 7/285; G06T 19/006; G06T 7/10; G06T 2207/10016; G06T 2207/30244

(57) ABSTRACT

A system and method for visual inertial navigation are described. In some embodiments, a device comprises an inertial measurement unit (IMU) sensor, a camera, a radio-based sensor, and a processor. The IMU sensor generates IMU data of the device. The camera generates a plurality of video frames. The radio-based sensor generates radio-based sensor data based on an absolute reference frame relative to the device. The processor is configured to synchronize the plurality of video frames with the IMU data, compute a first estimated spatial state of the device based on the synchronized plurality of video frames with the IMU data, compute a second estimated spatial state of the device based on the radio-based sensor data, and determine a spatial state of the device based on a combination of the first and second estimated spatial states of the device.

### TECHNICAL FIELD

The present application relates generally to the technical field of position and orientation determination of portable devices and, in various embodiments, to visual inertial navigation of devices such as head-mounted displays.

### BACKGROUND

Inertial Measurement Units (IMUs) such as gyroscopes and accelerometers can be used to track the position and orientation of a device in a three-dimensional space. Unfortunately, the tracking accuracy of the spatial position of the device degrades when the device moves in the three-dimensional space. For instance, the faster the device moves along an unconstrained trajectory in the three-dimensional space, the harder it is to track and identify the device in the three-dimensional space.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram illustrating a position and orientation determination device, in accordance with some example embodiments;

FIG. 2 is a block diagram illustrating a visual inertial navigation (VIN) module, in accordance with some example embodiments;

FIG. 3 is a block diagram illustrating an operation of the VIN module, in accordance with some example embodiments;

FIG. 4 is a block diagram illustrating another operation of the VIN module, in accordance with some example embodiments;

FIG. 5 is a block diagram illustrating a display device, in accordance with some example embodiments;

FIG. 6 is a block diagram illustrating an augmented reality application, in accordance with some example embodiments;

FIG. 7 is a flowchart illustrating a method for visual inertial navigation, in accordance with some example embodiments;

FIG. 8 is a flowchart illustrating another method for visual inertial navigation, in accordance with some example embodiments;

FIG. 9 is a flowchart illustrating another method for visual inertial navigation, in accordance with some example embodiments;

FIG. 10 is a flowchart illustrating a method of generating augmented reality content using visual inertial navigation, in accordance with some example embodiments;

FIG. 11 is a block diagram of an example computer system on which methodologies described herein may be executed, in accordance with some example embodiments; and

FIG. 12 is a block diagram illustrating a mobile device, in accordance with some example embodiments.

### DETAILED DESCRIPTION

Example methods and systems of visual inertial navigation (VIN) are disclosed. In the following description, for purposes of explanation, numerous specific details are set forth in order to provide a thorough understanding of example embodiments. It will be evident, however, to one skilled in the art that the present embodiments may be practiced without these specific details.

The present disclosure provides techniques for VIN. The absolute position or relative position of a VIN device in space can be tracked using sensors and a VIN module in the device. VIN is a method of estimating accurate position, velocity, and orientation (also referred to as state information) by combining visual cues with inertial information. In some embodiments, the device comprises an inertial measurement unit (IMU) sensor, a camera, a radio-based sensor, and a processor. The IMU sensor generates IMU data of the device. The camera generates a plurality of video frames. The radio-based sensor generates radio-based sensor data based on an absolute reference frame relative to the device. The processor is configured to synchronize the plurality of video frames with the IMU data, compute a first estimated spatial state of the device based on the synchronized plurality of video frames with the IMU data, compute a second estimated spatial state of the device based on the radio-based sensor data, and determine a spatial state of the device based on a combination of the first and second estimated spatial states of the device.

In one example embodiment, the device provides high fidelity (e.g., within several centimeters) absolute (global) positioning and orientation. The device performs sensor fusion amongst the several sensors in the device to determine the device's absolute location. For example, the device provides six degrees of freedom (6DOF) pose data at 100 Hz. This can include latitude, longitude, and altitude. The device combines data from all the sensors while one or more sensors lose and gain data collection. The camera may include a fisheye camera. The sensors may include IMUs (gyroscope and accelerometer), barometers, and magnetometers. The radio-based sensors may include ultra-wideband (UWB) input/output (for UWB localization) and GPS.

The device can be implemented in an Augmented Reality (AR) device. For example, the AR device may be a computing device capable of generating a display of virtual content or AR content layered on an image of a real-world object. The AR device may be, for example, a head-mounted device, a helmet, a watch, a visor, and eyeglasses. The AR device enables a wearer or user to view the virtual object layers on a view of real-world objects. The AR content may be generated based on the position and orientation of the AR device.

AR usage relies on very accurate position and orientation information with extremely low latency to render AR content over a physical scene on a see-through display. For example, an optimized VIN system can run at video frame rate, typically 60 Hz. With an IMU of a much higher data rate, typically 1000 Hz, accurate state information can be obtained with minimal latency for rendering. Since visual cues are used by VIN to correct IMU drift, IMU rate state information can still be very accurate. VIN can be extended to include other sensor inputs, such as GPS (Global Positioning System), so it can output state information in globally referenced coordinates. This consistent state information in turn can be used along with other sensors, for example, depth sensors, to construct a precise 3D map.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

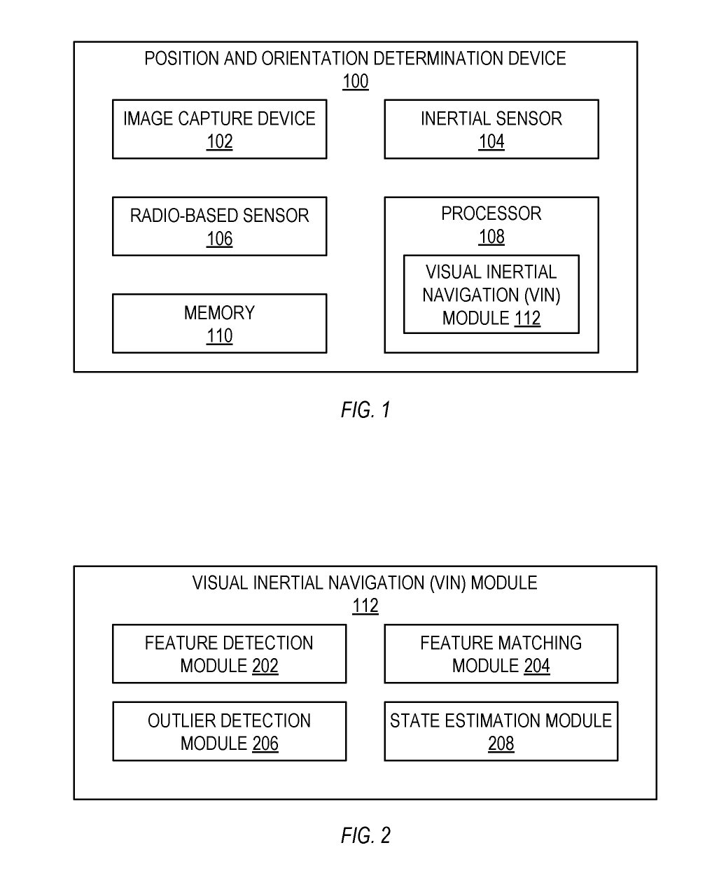

FIG. 1 is a block diagram illustrating a position and orientation determination device 100, in accordance with some example embodiments. The position and orientation determination device 100 comprises an image capture device 102 (e.g., camera), an inertial sensor 104 (e.g., gyroscope, accelerometer), a radio-based sensor 106 (e.g., WiFi, GPS, Bluetooth), a processor 108, and a memory 110.

In some embodiments, the image capture device 102 comprises a built-in camera or camcorder with which the position and orientation determination device 100 can capture image/video data of visual content in a real-world environment (e.g., a real-world physical object). The image data may comprise one or more still images or video frames.

In some embodiments, the inertial sensor 104 comprises an IMU sensor such as an accelerometer and/or a gyroscope with which the position and orientation determination device 100 can track its position over time. For example, the inertial sensor 104 measures an angular rate of change and linear acceleration of the position and orientation determination device 100. The position and orientation determination device 100 can include one or more inertial sensors 104.

In some embodiments, the radio-based sensor 106 comprises a transceiver or receiver for wirelessly receiving and/or wirelessly communicating wireless data signals. Examples of radio-based sensors include UWB units, WiFi units, GPS sensors, and Bluetooth units. In other embodiments, the position and orientation determination device 100 also includes other sensors such as magnetometers, barometers, and depth sensors for further accurate indoor localization.

In some embodiments, the processor 108 includes a visual inertial navigation (VIN) module 112 (stored in the memory 110 or implemented as part of the hardware of the processor 108, and executable by the processor 108). Although not shown, in some embodiments, the VIN module 112 may reside on a remote server and communicate with the position and orientation determination device 100 via a computer network. The network may be any network that enables communication between or among machines, databases, and devices. Accordingly, the network may be a wired network, a wireless network (e.g., a mobile or cellular network), or any suitable combination thereof. The network may include one or more portions that constitute a private network, a public network (e.g., the Internet), or any suitable combination thereof.

The VIN module 112 computes the position and orientation of the position and orientation determination device 100 based a combination of video data from the image capture device 102, inertial data from the inertial sensor 104, and radio-based sensor data from the radio-based sensor 106. In some example embodiments, the VIN module 112 includes an algorithm that combines information from the inertial sensor 104, the radio-based sensor 106, and the image capture device 102.

The VIN module 112 tracks, for example, the following data in order to compute the position and orientation of the position and orientation determination device 100 in space over time:
Stationary world points (xᵢ,yᵢ,zᵢ) where i represents the i^{th} world point,
Gyroscope measurements (gₓₜ, g_{yt}, g_{zt}),
Accelerometer measurements (aₓₜ, a_{yt}, a_{zt}),
Gyroscope bias (bgₓₜ,bg_{yt},bg_{zt}), and
Accelerometer bias (baₓₜ,ba_{yt},ba_{zt}), where t is time. The VIN module 112 may generate a 3D map that consists of an (x,y,z) for each stationary point in the real physical world being tracked.

In some example embodiments, the position and orientation determination device 100 may consist of one or more image capture devices 102 (e.g., cameras) mounted on a rigid platform with one or more IMU sensors. The one or more image capture devices 102 can be mounted with non-overlapping (distributed aperture) or overlapping (stereo or more) fields of view.

The inertial sensor 104 measures angular rate of change and linear acceleration. The image capture device 102 tracks features in the video images. The image features could be corner or blob features extracted from the image. For example, first and second local patch differentials over the image could be used to find corner and blob features. The tracked image features are used to infer 3D geometry of the environment and are combined with the inertial information to estimate position and orientation of the position and orientation determination device 100.

For example, the 3D location of a tracked point is computed by triangulation that uses the observation of the 3D point in all cameras over time. The 3D estimate is improved as additional evidence or data is accumulated over time. The VIN module 112 minimizes the re-projection of the 3D points into the cameras over time, and the residual between the estimate and the IMU propagation estimate. The IMU propagation solves the differential equations from an estimated rig state used as an initial starting point at time k, propagating the state to the next rig at k+1 using the gyroscope and accelerometer data between the rigs.

In some embodiments, the VIN module 112 is used to accurately localize the position and orientation determination device 100 in space and simultaneously map the 3D geometry of the space around the position and orientation determination device 100. The position and orientation of the position and orientation determination device 100 can be used in an AR system by knowing precisely where the AR system is in real time and with low latency to project a virtual world into a display of the AR system. The relation between the IMU/camera and the display system is known and calibrated off line during a calibration process. The calibration process consists of observing a known 2D or 3D pattern in the world in all the cameras on the position and orientation determination device 100 and IMU data over several frames. The pattern is detected in every frame and used to estimate the placement of the cameras and IMU on the position and orientation determination device 100.

In one example embodiment, the VIN module 112 performs local synchronization and GPS synchronization to fuse video sensors and inertial sensors based on precise time synchronization of their respective samples. Local synchronization is implemented by sourcing a local time event to the sensors which can accept it (e.g, camera, IMU). Sensor events are timestamped when sensors accept external triggers or produce events after being triggered. For example, camera and IMU data is timestamp based on hardware triggers directly from the sensor. GPS data could be timestamped by the GPS which disciplines itself to the GPS atomic clock. The present system uses a PulsePerSecond (PPS) signal going into the hardware which will be used to discipline an internal clock. The local synchronization relies on a clock source with low jitter (10 ps RMS jitter), high precision (no more than 10 ppm from nominal over 40° C. to 85° C.), and high frequency stability (20 ppm over temperature, voltage, and aging). The gyroscope and accelerometer readings are synchronized to less than 1 microsecond. The time drift between the capture time of video frames, the middle of video exposure times, and the capture time of IMU samples is less than 10 microseconds after offset compensation.

GPS is used as a time reference and for global localization. GPS can be synchronized to an absolute clock and also to OnePulsePerSecond output from the GPS receiver so that a VIN clock source can be disciplined to the GPS time. The GPS velocity measurement can be computed from Doppler effects from device motion which can achieve centimeter-per-second accuracy. To associate other devices, such as a motion capture system for VIN evaluation, the local clock is disciplined with a GPS clock similar to the VIN clock. For example, the VIN clock is disciplined with the GPS clock when it is available (e.g., when the device can access and receive GPS signals). Timestamps based on the VIN clock are increased and reset when needed. Timestamps based on the VIN clock are associated with GPS global timestamps accurately within 0.01 ms error.

The memory 110 includes a storage device such as a flash memory or a hard drive. The memory 110 stores the 3D location of the tracked point computed by triangulation. The memory 110 also stores machine-readable code representing the VIN module 112.

FIG. 2 is a block diagram illustrating a visual inertial navigation (VIN) module 112, in accordance with some example embodiments. The VIN module 112 includes, for example, a feature detection module 202, a feature matching module 204, an outlier detection module 206, and a state estimation module 208. The feature detection module 202 uses an algorithm to detect and track features in the video frames of a video sequence. In one example embodiment, a Harris corners technique is used to generate features on each individual video frame. From the Harris corners, feature matches across consecutive video frames are found by measuring the normalized cross-correlation (NCC) between small image windows centered on the Harris corners, and used to form feature tracks. Other feature detection techniques, such as difference of Gaussian (DoG) blobs, may be used.

The feature matching module 204 matches features between adjacent image frames, such as by NCC feature matching. For example, the feature matching module 204 may use a mutual correspondence feature matching method as first-stage pruning for inlier matches.

The outlier detection module 206 tracks individual features that are vulnerable to noise and to data association issues which can cause the feature tracks to be corrupted. The outlier detection module 206 detects and rejects these features as outliers by using a three-step outlier rejection scheme. As a first step for a feature, the feature is tracked for at least Nt frames. This implicitly removes many outliers, as it is less likely for an outlier track to be consistent across several frames. In the second step, a two-point outlier detection method is employed at each frame given tracks from the past Nt frames. At the current frame, three equally spaced frames in time are selected. Next, rotations between pairs of frames are estimated using gyroscope measurements. Following this, a preemptive random sample consensus (RANSAC) scheme is used to hypothesize translations between pairs of frames given randomly selected tracks and gyro rotations. Given a translation hypothesis and rotations, the trifocal tensor for the three frames is constructed. The tensor is then used to compute the perturbation error of all tracks in the three frames and the translation hypothesis with the lowest error is selected. The best hypothesis is then used to identify tracks with large perturbation errors, and those tracks are marked as outliers and discarded. In the third step, a track's triangulated position and inverse depth and variance are used to remove tracks that are either too far away or have large variances.

The state estimation module 208 solves for the position, orientation, velocity, and IMU dynamics of the position and orientation determination device 100. Example implementations of the state estimation module 208 include an extended Kalman filter, a bundle adjuster, or similar algorithms.

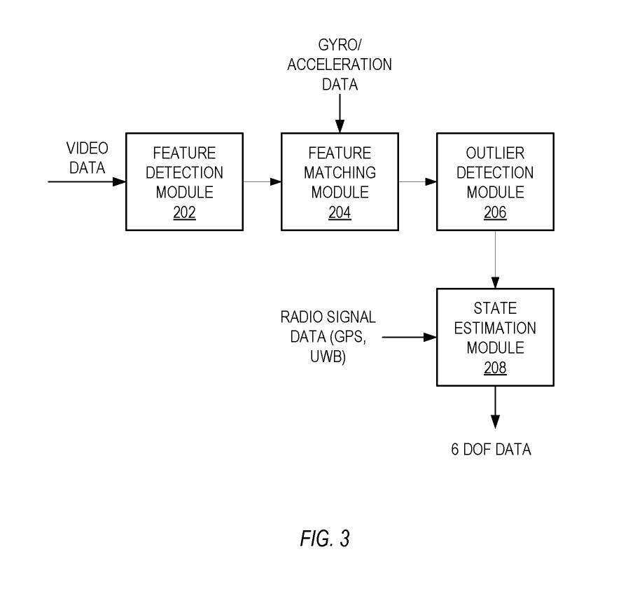

FIG. 3 is a block diagram illustrating an operation of the VIN module 112, in accordance with some example embodiments. The feature detection module 202 receives video data (e.g., video frames) from the image capture device 102. As previously described with respect to FIG. 2, the feature detection module 202 detects and tracks features in the video frames. The feature matching module 204 uses the IMU sensor data (e.g., gyroscope and accelerometer data) to match features between adjacent image frames (e.g., inlier matches). The outlier detection module 206 detects outliers as previously described with respect to FIG. 2. The state estimation module 208 uses the radio-based signal data to perform an extended Kalman filter on the video frames to generate 6DOF pose data. For example, the state estimation module 208 fuses the sensor information to track the full state (e.g., position, orientation, velocity, sensor biases, etc.) of the position and orientation determination device 100.

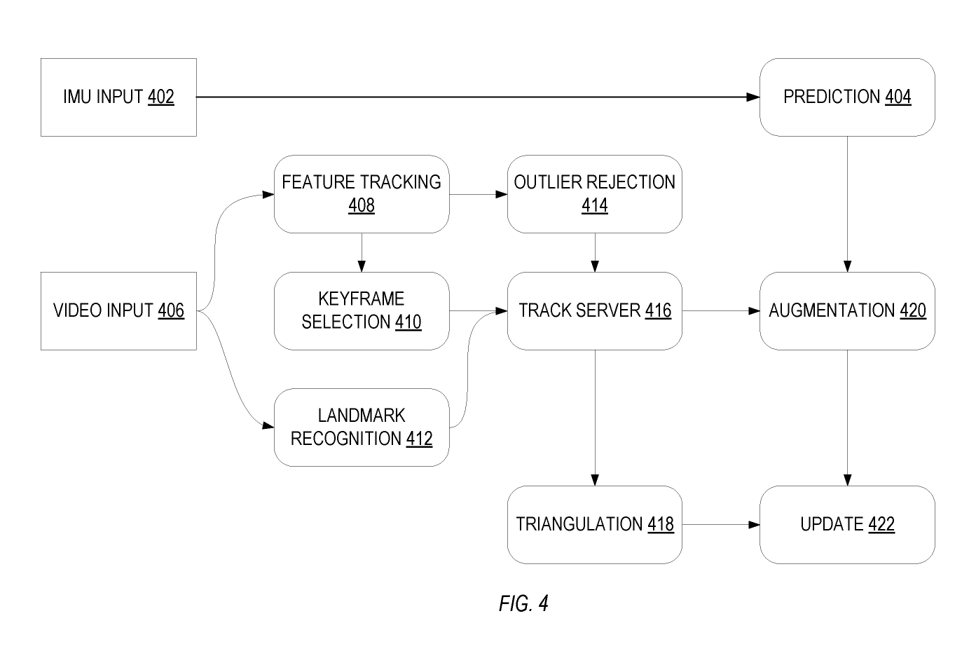

FIG. 4 is a block diagram illustrating another operation of the VIN module 112, in accordance with some example embodiments. IMU input 402 includes IMU sensor data from the inertial sensor 104. The VIN module 112 computes a state prediction 404 based on the IMU sensor data. For example, the VIN module 112 uses an extended Kalman filter (EKF) framework to perform the state estimation (e.g., state prediction 404). The goal of the EKF is to accurately estimate the pose of a rig, in particular the IMU, at a video frame rate either with respect to an arbitrary origin or with respect to any known landmarks in the environment. To achieve this, several quantities are tracked and estimated as part of the EKF state. These include: (i) IMU pose (position and orientation), velocity, and biases at the current time; (ii) IMU poses at previous times (called clones); (iii) 3D landmark poses; and (iv) feature (or track) inverse depths. More precisely, the EKF estimates the error in these quantities in addition to the EKF state. The error state has zero mean but has approximately (due to linearization) the same covariance as the state. Thus tracking the error state covariance is approximately equivalent to tracking the state covariance.

A video input 406 includes video data (e.g., video frames) from the image capture device 102. The VIN module 112 operates on the video data to perform a feature tracking 408, keyframe selection 410, and landmark recognition 412. For example, the VIN module 112 tracks natural features (feature tracking 408) in the environment across multiple camera frames while removing outlying features (outlier rejection 414) that do not satisfy certain conditions.

In some example embodiments, the feature tracking 408 tracks features in video frames for one or more cameras. There is one feature tracker for each image capture device 102. The feature tracking 408 receives the video frames and tracks features in the image over time. The features could be interest points or line features. The feature tracking 408 consists of extracting a local descriptor around each feature and matching it to subsequent camera frames. The local descriptor could be a neighborhood pixel patch that is matched by using, for example, NCC.

In one example embodiment, the feature tracking 408 detects, for example, centered 5×5 weighted Harris scores for every image pixel, performs 5×5 non-max suppression over every pixel to find local extrema, performs sub-pixel refinement by using a 2d quadratic fitting, and uses normalized cross-correlations to find matches between two adjacent frames.

The keyframe selection 410 determines whether there is no last keyframe. If so, the keyframe selection 410 selects the current frame as a keyframe if there is sufficient image texture, otherwise it waits for the next frame. The keyframe selection 410 estimates the affine transformation between current frame and the last keyframe. If there is sufficient distance between the current frame and last keyframe then the keyframe selection 410 selects the current frame as a keyframe if there is sufficient texture, otherwise it waits for the next frame.

The landmark recognition 412 computes rotation and scale invariant features on image, adds features to a visual database, matches features to previous keyframes, and if a match is found, adds constraints to the tracker server 416.

The track server 416 includes a bi-partite graph storing the constraints between image frames and 3D map.

The keyframe selection 410 and landmark recognition 412 are provided to a track server 416 for augmentation 420 of the state. A triangulation 418 based on the track server 416 can be used to update 422 the state.

The triangulation 418 triangulates features that have not been triangulated using all views of the features stored in the Track Server 416. The triangulation 418 is performed by minimizing the re-projection error on the views.

The feature correspondences are used to compute the 3D positions of each feature (triangulation 418), which serve to constrain the relative camera (or IMU) poses across multiple frames through minimization of the reprojection error (update 422). IMU data is used to further constrain the camera poses by predicting the expected camera pose from one frame to the next (state prediction 404). Other major components of the VIN include detecting and tracking landmarks in the world (landmark recognition 412); selecting distinctive camera frames (keyframe selection 410); and augmentation of the EKF state (augmentation 420).

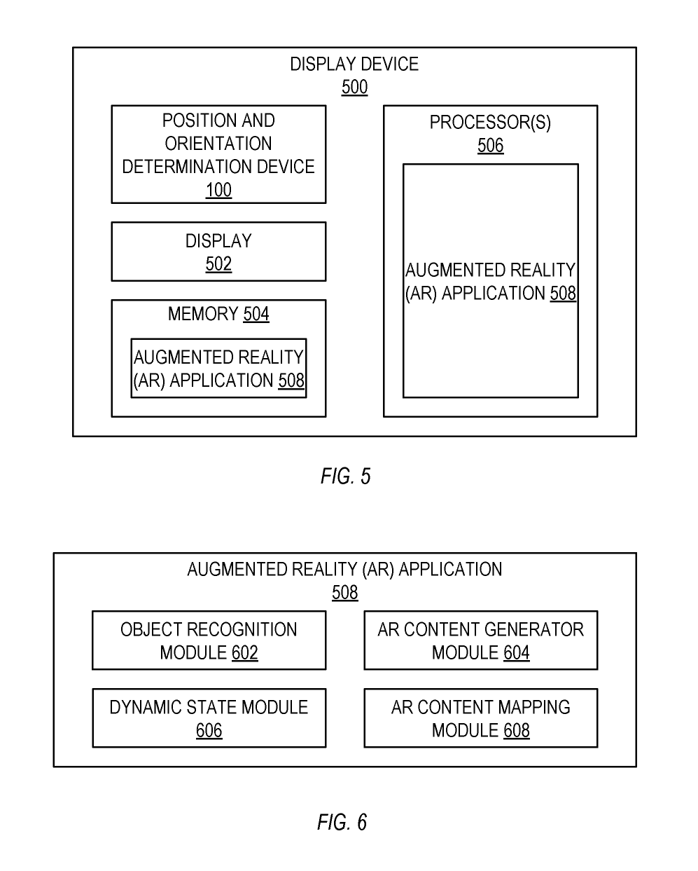

FIG. 5 is a block diagram illustrating a display device 500, in accordance with some example embodiments. The display device 500 may be, for example, a smart phone, a tablet computer, a wearable device, a heads-up display device, a vehicle display device, or any computing device. The display device 500 includes the position and orientation determination device 100, a display 502, a memory 504, and a processor 506. The display 502 includes, for example, a transparent display that displays virtual content.

The image capture device 102 of the position and orientation determination device 100 can be used to gather image data of visual content in a real-world environment (e.g., a real-world physical object). The image data may comprise one or more still images or video. In another example embodiment, the display device 500 may include another camera aimed toward at least one of a user's eyes to determine a gaze direction of the user's eyes (e.g., where the user is looking or the rotational position of the user's eyes relative to the user's head or some other point of reference).

The position and orientation determination device 100 provides a spatial state of the display device 500 over time. The spatial state includes, for example, a geographic position, orientation, velocity, and altitude of the display device 500. The spatial state of the display device 500 can then be used to generate and display AR content in the display 502. The location of the AR content within the display 502 may also be adjusted based on the dynamic state (e.g., position and orientation) of the display device 500 in space over time relative to stationary objects sensed by the image capture device(s) 102.

In some embodiments, the display 502 is configured to display the image data captured by the image capture device 102 or any other camera of the display device 500. In some embodiments, the display 502 is transparent or semi-opaque so that the user of the display device 500 can see through the display 502 to view the virtual content as a layer on top of the real-world environment.

In some example embodiments, an augmented reality (AR) application 508 is stored in the memory 504 or implemented as part of the hardware of the processor 506, and is executable by the processor 506. The AR application 508 provides AR content based on identified objects in a physical environment and a spatial state of the display device 500. The physical environment may include identifiable objects such as a 2D physical object (e.g., a picture), a 3D physical object (e.g., a factory machine), a location (e.g., at the bottom floor of a factory), or any references (e.g., perceived corners of walls or furniture) in the real-world physical environment. The AR application 508 may include computer vision recognition capabilities to determine corners, objects, lines, and letters. Example components of the AR application 508 are described in more detail below with respect to FIG. 6.

FIG. 6 is a block diagram illustrating the AR application 508, in accordance with some example embodiments. The AR application 508 includes an object recognition module 602, a dynamic state module 606, an AR content generator module 604, and an AR content mapping module 608.

The object recognition module 602 identifies objects that the display device 500 is pointed to. The object recognition module 602 detects, generates, and identifies identifiers such as feature points of a physical object being viewed or pointed at by the display device 500 using the image capture device 102 to capture the image of the physical object. As such, the object recognition module 602 may be configured to identify one or more physical objects. In one example embodiment, the object recognition module 602 identifies objects in many different ways. For example, the object recognition module 602 determines feature points of the physical object based on several image frames of the object. The identity of the physical object is also determined by using any visual recognition algorithm. In another example, a unique identifier may be associated with the physical object. The unique identifier may be a unique wireless signal or a unique visual pattern such that the object recognition module 602 can look up the identity of the physical object based on the unique identifier from a local or remote content database.

The dynamic state module 606 receives data identifying the latest spatial state (e.g., location, position, and orientation) of the display device 500 from the position and orientation determination device 100.

The AR content generator module 604 generates AR content based on an identification of the physical object and the spatial state of the display device 500. For example, the AR content may include visualization of data related to a physical object. The visualization may include rendering a 3D object (e.g., a virtual arrow on a floor) or a 2D object (e.g., an arrow or symbol next to a machine), or displaying other physical objects in different colors visually perceived on other physical devices.

The AR content mapping module 608 maps the location of the AR content to be displayed in the display 502 based on the dynamic state (e.g., spatial state of the display device 500). As such, the AR content may be accurately displayed based on a relative position of the display device 500 in space or in a physical environment. When the user moves, the inertial position of the display device 500 is tracked and the display of the AR content is adjusted based on the new inertial position. For example, the user may view a virtual object visually perceived to be on a physical table. The position, location, and display of the virtual object is updated in the display 502 as the user moves around (e.g., away from, closer to, around) the physical table.

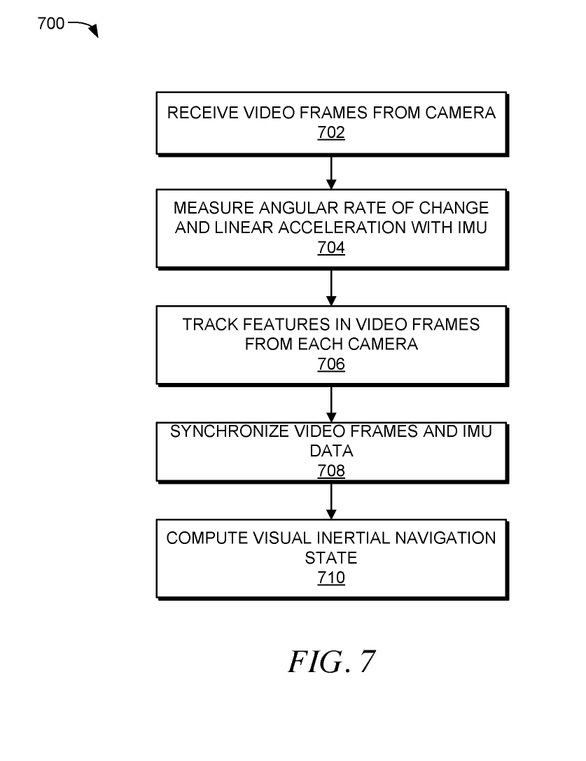

FIG. 7 is a flowchart illustrating a method 700 for VIN, in accordance with some example embodiments. At operation 702, the VIN module 112 receives video frames from a camera of the position and orientation determination device 100. In some example embodiments, operation 702 may be implemented with the image capture device 102. The image capture device 102 generates the video frames.

At operation 704, the VIN module 112 measures the angular rate of change and linear acceleration. In some example embodiments, operation 704 may be implemented using the inertial sensor 104.

At operation 706, the VIN module 112 tracks features in the video frames from one or more cameras. In some example embodiments, operation 706 is implemented using the feature detection module 202.

At operation 708, the VIN module 112 synchronizes the video frames with the IMU data (e.g., angular rate of change and linear acceleration) from operation 704. In some example embodiments, operation 708 is implemented using the feature matching module 204.

At operation 710, the VIN module 112 computes a spatial state based on the synchronized video frames. In some example embodiments, operation 710 is implemented using the state estimation module 208.

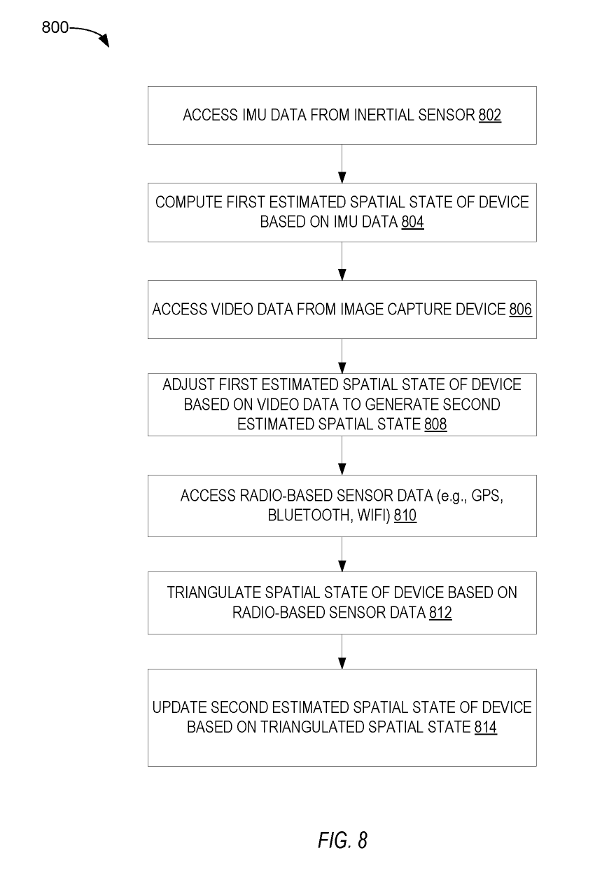

FIG. 8 is a flowchart illustrating another method 800 for VIN, in accordance with some example embodiments. At operation 802, the VIN module 112 accesses IMU data from the inertial sensor 104. At operation 804, the VIN module 112 computes a first estimated spatial state of the position and orientation determination device 100 based on the IMU data. In some example embodiments, operation 804 may be implemented using the state estimation module 208. At operation 806, the VIN module 112 accesses video data from the image capture device 102. At operation 808, the VIN module 112 adjusts the first estimated spatial state of the position and orientation determination device 100 based on the video data to generate a second estimated spatial state. In some example embodiments, operation 808 may be implemented using the feature detection module 202 and the feature matching module 204. At operation 810, the VIN module 112 accesses radio-based sensor data (e.g., GPS data, Bluetooth data, WiFi data, UWB data) from the radio-based sensor 106. At operation 812, the VIN module 112 triangulates the location or spatial state of the position and orientation determination device 100 based on the radio-based sensor data. At operation 814, the VIN module 112 updates the second estimated spatial state of the position and orientation determination device 100 based on the triangulated location. In some embodiments, the operation 814 may be implemented using the state estimation module 208.

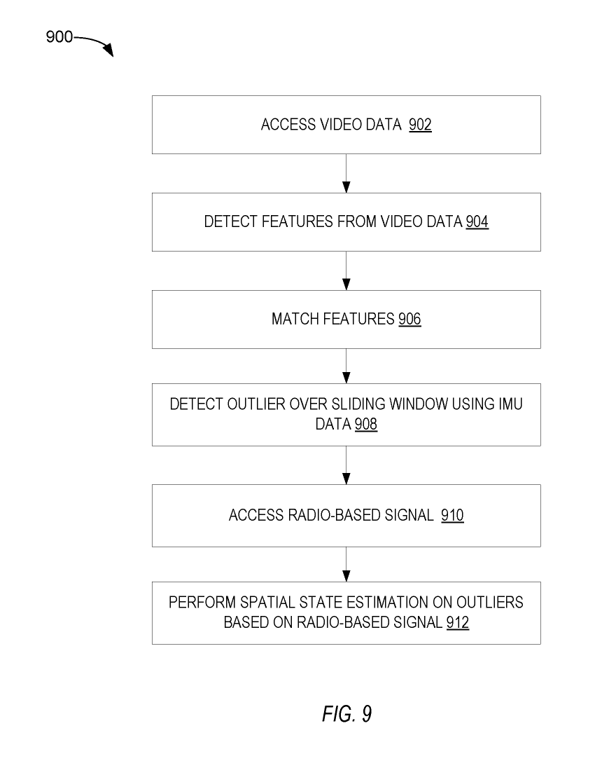

FIG. 9 is a flowchart illustrating another method 900 for VIN, in accordance with some example embodiments. At operation 902, the VIN module 112 accesses video data from the image capture device 102. At operation 904, the VIN module 112 detects features from the video data. In some example embodiments, operation 904 may be implemented using the feature detection module 202. At operation 906, the VIN module 112 matches the features from adjacent video frames from the video data. In some example embodiments, operation 906 may be implemented with the feature matching module 204. At operation 908, the VIN module 112 detects outliers over a sliding window using IMU data. In some example embodiments, operation 908 may be implemented using the outlier detection module 206.

At operation 910, the VIN module 112 accesses radio-based sensor data (e.g., GPS data, Bluetooth data, WiFi data, UWB data) from the radio-based sensor 106. At operation 912, the VIN module 112 performs a spatial state estimation on outliers based on the radio-based sensor data. In some embodiments, the operation 814 may be implemented using the state estimation module 208.

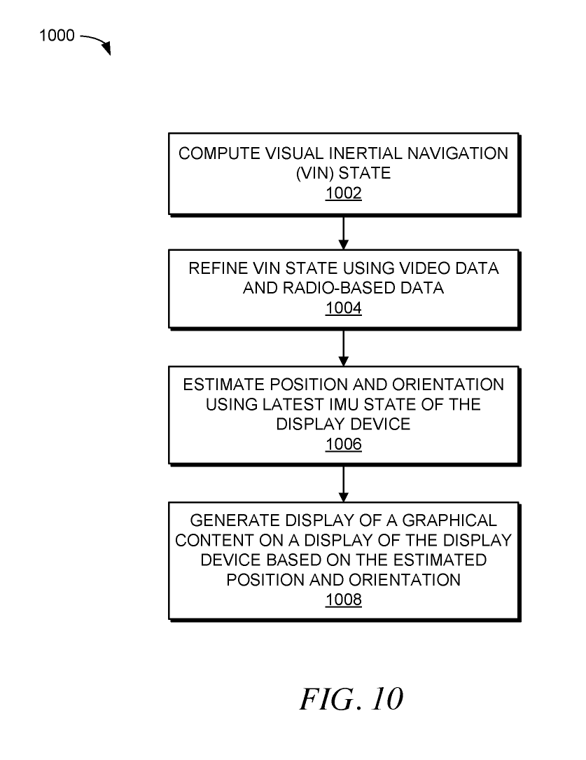

FIG. 10 is a flowchart illustrating a method 1000 of generating augmented reality content using VIN, in accordance with some embodiments. At operation 1002, the display device 500 computes a VIN state. In some example embodiments, operation 1002 is implemented using the VIN module 112.

At operation 1004, the VIN module 112 refines the VIN state using video data and radio-based data. In some example embodiments, operation 1004 is implemented using the state estimation module 208.

At operation 1006, the VIN module 112 estimates the position and orientation of the display device 500 using the latest IMU state of the display device 500. In some example embodiments, operation 1006 is implemented using the state estimation module 208.

At operation 1008, the display device 500 generates a display of graphical content (e.g., virtual content) on the display 502 of the display device 500 based on the estimated position and orientation of the display device 500. In some example embodiments, operation 1008 is implemented using the state estimation module 208.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network and via one or more appropriate interfaces (e.g., application programming interfaces (APIs)).

Example embodiments may be implemented in digital electronic circuitry, in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

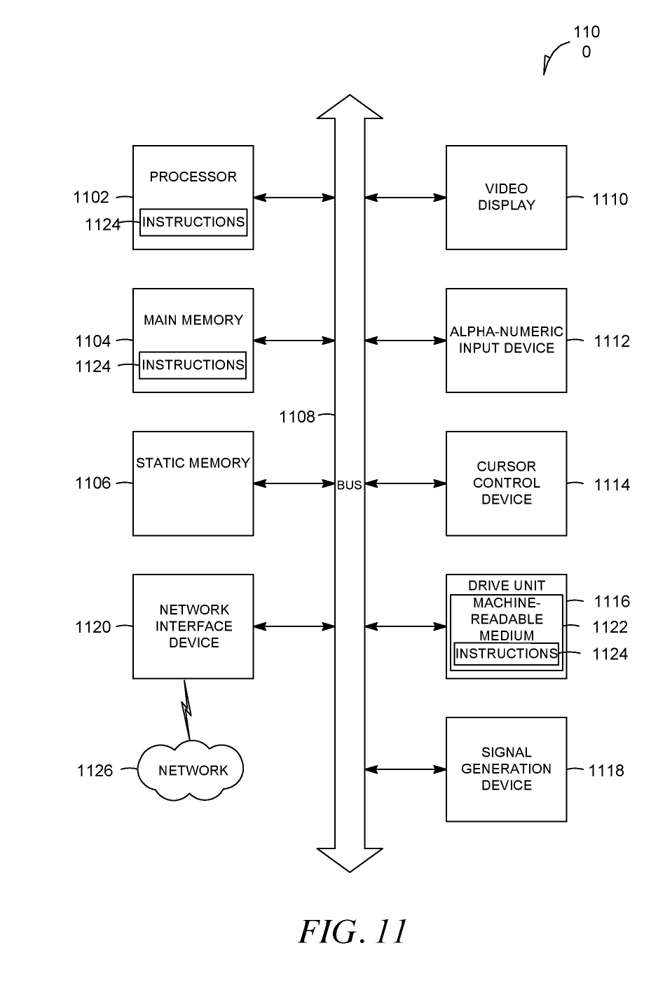

FIG. 11 is a block diagram of a machine in the example form of a computer system 1100 within which instructions 1124 for causing the machine to perform any one or more of the methodologies discussed herein may be executed, in accordance with an example embodiment. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU), or both), a main memory 1104, and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation (or cursor control) device 1114 (e.g., a mouse), a disk drive unit 1116, a signal generation device 1118 (e.g., a speaker), and a network interface device 1120.

The disk drive unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media. The instructions 1124 may also reside, completely or at least partially, within the static memory 1106.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding, or carrying instructions for execution by the machine and that cause the machine to perform any one or more of the methodologies of the present embodiments, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 1124 may further be transmitted or received over a communications network 1126 using a transmission medium. The instructions 1124 may be transmitted using the network interface device 1120 and any one of a number of well-known transfer protocols (e.g., hypertext transfer protocol (HTTP)). Examples of communication networks include a local area network (LAN), a wide-area network (WAN), the Internet, mobile telephone networks, plain old telephone service (POTS) networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

### EXAMPLE MOBILE DEVICE

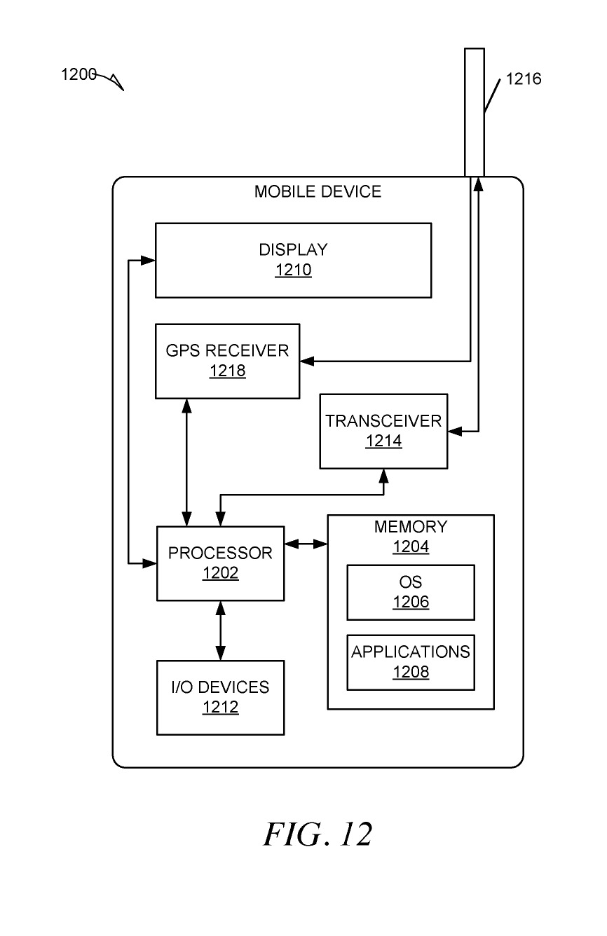

FIG. 12 is a block diagram illustrating a mobile device 1200 that may employ the VIN state computation features of the present disclosure, according to an example embodiment. The mobile device 1200 may include a processor 1202. The processor 1202 may be any of a variety of different types of commercially available processors 1202 suitable for mobile devices 1200 (for example, an XScale architecture microprocessor, a microprocessor without interlocked pipeline stages (MIPS) architecture processor, or another type of processor 1202). A memory 1204, such as a random access memory (RAM), a flash memory, or another type of memory, is typically accessible to the processor 1202. The memory 1204 may be adapted to store an operating system (OS) 1206, as well as application programs 1208, such as a mobile location enabled application that may provide location-based services (LBSs) to a user. The processor 1202 may be coupled, either directly or via appropriate intermediary hardware, to a display 1210 and to one or more input/output (I/O) devices 1212, such as a keypad, a touch panel sensor, a microphone, and the like. Similarly, in some embodiments, the processor 1202 may be coupled to a transceiver 1214 that interfaces with an antenna 1216. The transceiver 1214 may be configured to both transmit and receive cellular network signals, wireless data signals, or other types of signals via the antenna 1216, depending on the nature of the mobile device 1200. Further, in some configurations, a GPS receiver 1218 may also make use of the antenna 1216 to receive GPS signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The following enumerated embodiments describe various example embodiments of methods, machine-readable media, and systems (e.g., machines, devices, or other apparatus) discussed herein.

A first embodiment provides a device (e.g., a position and orientation determination device) comprising:
an inertial measurement unit (IMU) sensor configured to generate IMU data of the device;
a camera configured to generate a plurality of video frames;
a radio-based sensor configured to generate radio-based sensor data based on an absolute reference frame relative to the device; and
a visual inertial navigation (VIN) module, executable by at least one hardware processor, configured to:
synchronize the plurality of video frames with the IMU data;
compute a first estimated spatial state of the device based on the synchronized plurality of video frames with the IMU data;
compute a second estimated spatial state of the device based on the radio-based sensor data; and
determine a spatial state of the device based on a combination of the first and second estimated spatial states of the device.

A second embodiment provides a device according to any one of the preceding embodiments, wherein the VIN module is further configured to:
detect and track at least one feature in a video sequence of the plurality of video frames;
match the at least one feature between adjacent video frames to detect inliers;
detect outliers over a sliding window of video frames using the IMU data; and
compute the first estimated spatial state of the device based on detecting the outliers and the inliers,
wherein the spatial state of the device includes a position, an orientation, and a velocity of the device.

A third embodiment provides a device according to any one of the preceding embodiments, wherein the VIN module is further configured to:
compute the first estimated spatial state of the device based on the synchronized plurality of video frames with the IMU data for a period of time during which the device is without access to the radio-based sensor data;
access a second radio-based sensor data generated after the period of time;
compute the second estimated spatial state of the device based on the second radio-based sensor data; and
adjust the first estimated spatial state of the device based on the second estimated spatial state of the device.

A fourth embodiment provides a device according to any one of the preceding embodiments, wherein the IMU sensor operates at a refresh rate higher than that of the camera, and wherein the radio-based sensor comprises at least one of a GPS sensor and a wireless sensor.

A fifth embodiment provides a device according to the any one of the preceding embodiments, wherein the VIN module is further configured to:

determine a historical trajectory of the device based on the combination of the first and second estimated spatial states of the device.

A sixth embodiment provides a device according to any one of the preceding embodiments, further comprising:
a synchronization module configured to synchronize and align the plurality of video frames for each camera of a plurality of cameras based on the IMU data;
the visual inertial navigation (VIN) module configured to compute the spatial state of the device based on the synchronized plurality of video frames with the IMU data; and
an augmented reality content module configured to generate and position augmented reality content in a display of the device based on the spatial state of the device.

A seventh embodiment provides a device according to any one of the preceding embodiments, further comprising:
a calibration module configured to calibrate the camera offline for focal length, principal point, pixel aspect ratio, and lens distortion, to calibrate the IMU sensor for noise, scale, and bias, and to apply calibration information to the plurality of video frames and the IMU data.

An eight embodiment provides a device according to any one of the preceding embodiments, wherein the IMU data comprises an angular rate of change and a linear acceleration.

A ninth embodiment provides a device according to any one of the preceding embodiments, wherein the feature comprises predefined stationary interest points and line features.

A tenth embodiment provides a device according to any one of the preceding embodiments, wherein the VIN module is further configured to:
update the spatial state on every video frame from the camera in real time; and
adjust a position of augmented reality content in a display of the device based on a latest spatial state of the device.

1. A device comprising:
an inertial measurement unit (IMU) sensor configured to generate IMU data of the device;
a camera configured to generate a plurality of video frames;
a radio-based sensor configured to generate radio-based sensor data based on an absolute reference frame relative to the device; and
at least one hardware processor comprising a visual inertial navigation (VIN) application, the VIN application being configured to perform operations comprising:
synchronize the plurality of video frames with the IMU data using a reference clock source of the radio-based sensor, the reference clock source controlling both the time data from the plurality of video frames and the IMU data;
compute a first estimated spatial state of the device based on the synchronized plurality of video frames with the IMU data;
compute a second estimated spatial state of the device based on the radio-based sensor data; and
determine a spatial state of the device based on a combination of the first and second estimated spatial states of the device.

2. The device of claim 1, wherein the operations further comprise:
detect and track at least one feature in a video sequence of the plurality of video frames;
match the at least one feature between adjacent video frames to detect inliers;
detect outliers over a sliding window of video frames of the plurality of video frames using the IMU data; and
compute the first estimated spatial state of the device based on detecting the outliers and the inliers, wherein the spatial state of the device includes a position, an orientation, and a velocity of the device.

3. The device of claim 1, wherein the operations further comprise:
compute the first estimated spatial state of the device based on the synchronized plurality of video frames with the IMU data for a period of time during which the device is without access to the radio-based sensor data;
access a second radio-based sensor data generated after the period of time;
compute the second estimated spatial state of the device based on the second radio-based sensor data;
adjust the first estimated spatial state of the device based on the second estimated spatial state of the device;
access the reference clock source of the sensor-based sensor after the period of time; and
adjust a clock of the IMU sensor based on the reference clock source.

4. The device of claim 3, wherein the IMU sensor operates at a refresh rate higher than that of the camera, and wherein the radio-based sensor comprises at least one of a GPS sensor and a wireless sensor.

5. The device of claim 2, wherein the operations further comprise:
determine a historical trajectory of the device based on the combination of the first and second estimated spatial states of the device.

6. The device of claim 1, wherein the operations further comprise:
generate and position augmented reality content in a display of the device based on the spatial state of the device.

7. The device of claim 6, wherein the operations further comprise:
calibrate the camera offline for focal length, principal point, pixel aspect ratio, and lens distortion, to calibrate the IMU sensor for noise, scale, and bias.

8. The device of claim 1, wherein the IMU data comprises an angular rate of change and a linear acceleration.

9. The device of claim 2, wherein the feature comprises predefined stationary interest points and line features.

10. The device of claim 2, wherein the operations further comprise:
update the spatial state of the device based on every video frame from the camera in real time; and
adjust a position of augmented reality content in a display of the device based on a latest spatial state of the device.

11. A computer-implemented method comprising:
accessing inertial measurement unit (IMU) data from at least one IMU sensor of a device;
accessing a plurality of video frames from a camera of the device;
accessing radio-based sensor data from a radio-based sensor, the radio-based sensor data based on an absolute reference frame relative to the device;
synchronizing the plurality of video frames with the IMU data using a reference clock source of the radio-based sensor, the reference clock source controlling both the time data from the plurality of video frames and the IMU data;
computing a first estimated spatial state of the device based on the synchronized plurality of video frames with the IMU data;
computing a second estimated spatial state of the device based on the radio-based sensor data; and
determining a spatial state of the device based on a combination of the first and second estimated spatial states of the device.

12. The computer-implemented method of claim 11, further comprising:
detecting and tracking at least one feature in a video sequence of the plurality of video frames;
matching the at least one feature between adjacent video frames to detect inliers;
detecting outliers over a sliding window of video frames of the plurality of video frames using the IMU data; and
computing the first estimated spatial state of the device based on detecting the outliers and the inliers, wherein the spatial state of the device includes a position, an orientation, and a velocity of the device.

13. The computer-implemented method of claim 11, further comprising:
computing the first estimated spatial state of the device based on the synchronized plurality of video frames with the IMU data for a period of time during which the device is without access to the radio-based sensor data;
accessing a second radio-based sensor data generated after the period of time;
computing the second estimated spatial state of the device based on the second radio-based sensor data;
adjusting the first estimated spatial state of the device based on the second estimated spatial state of the device;
accessing the reference clock source of the radio-based sensor after the period of time; and
adjusting a clock of the IMU sensor based on the reference clock source.

14. The computer-implemented method of claim 11, wherein the IMU sensor operates at a refresh rate higher than that of the camera.

15. The computer-implemented method of claim 13, further comprising:
determining a historical trajectory of the device based on the combination of the first and second estimated spatial states of the device.

16. The computer-implemented method of claim 11, further comprising:
generating and positioning augmented reality content in a display of the device based on the spatial state of the device.

17. The computer-implemented method of claim 16, further comprising:
calibrating the camera offline for focal length, principal point, pixel aspect ratio, and lens distortion;
calibrating the IMU sensor for noise, scale, and bias.

18. The computer-implemented method of claim 11, wherein the IMU data comprises an angular rate of change and a linear acceleration.

19. The computer-implemented method of claim 12, wherein the feature comprises predefined stationary interest points and line features.

20. A non-transitory machine-readable storage medium, tangibly embodying a set of instructions that, when executed by at least one processor, causes the at least one processor to perform a set of operations comprising:
accessing inertial measurement unit (IMU) data from at least one IMU sensor of a device;
accessing a plurality of video frames from a camera of the device;
accessing radio-based sensor data from a radio-based sensor, the radio-based sensor data based on an absolute reference frame relative to the device;
synchronizing the plurality of video frames with the IMU data using a reference clock source of the radio-based sensor, the reference clock source controlling both the time data from the plurality of video frames and the IMU data;
computing a first estimated spatial state of the device based on the synchronized plurality of video frames with the IMU data;
computing a second estimated spatial state of the device based on the radio-based sensor data; and
determining a spatial state of the device based on a combination of the first and second estimated spatial states of the device.
